(19) United States
(12) Patent Application Publication
(10) Pub. No.: US 2006/0121775 A1
(43) Pub. Date: Jun. 8, 2006

(54) Connector plug

(76) Inventor: Aloys Wobben, Aurich (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/525,657

(22) PCT Filed: Jul. 12, 2003
(86) PCT No.: PCT/EP03/07555

§ 371 Date: Aug. 18, 2005

(30) Foreign Application Priority Data
Aug. 28, 2002 (DE) 120 39 421.0

(51) Int. Cl. H01R 13/58

(52) U.S. Cl. 439/473

(57) ABSTRACT

The present invention provides a plug connector in order to extend the uses of the plug connector. A plug connector comprising a plug housing and a first bushing for a cable having at least a first and second conductor, a contact insert for the first conductor integrated in said housing, means for fixating the cable in the bushing area, and a second cable bushing, characterized in that the second conductor is fed out of the housing through the second cable bushing.

### BACKGROUND OF THE INVENTION

1. Field of the Invention

The invention relates to a plug connector for both optical and electrical cables to pass there through.

2. Description of the Related Art

A plug connector of this kind is known from DE 195 26 267 A1, for example.

In said known plug connector, a copper conductor and an optical waveguide are jointly fed through a common cable gland into a plug housing, and the different cables are connected to corresponding contact inserts. The copper conductor comprised of two copper leads is thus connected to the standard earthed contacts as connectors, whereas the optical waveguide is connected to an optical waveguide connector. However, a particular disadvantage of this known solution is that it can only be used in setups in which the mating contacts are likewise configured in such a way that the respective conductors can also be connected to their matching conductors.

A plug connector housing with two cable bushings is known from DE 198 03 677. However, this document discloses that a conductor end is fed through each of the two bushings into the plug housing, where they can be connected or looped through in the desired manner. Such loopthrough then necessitates an electrical connection for the respective conductors of the two cables, however.

DE 43 37 905 shows a plug connection with a plurality of openings through which galvanic conductors and optical conductors can be fed. In the plug connection disclosed therein, connections for galvanic conductors and connections for optical conductors are described.

### BRIEF SUMMARY OF THE INVENTION

The technical problem of the present invention is to develop a plug connector of the kind initially specified in order to extend the uses of the plug connector. This problem is solved with a plug connector having the features pursuant to claim 1. Advantageous embodiments are described in the subclaims.

### BRIEF DESCRIPTION OF THE SEVERAL VIEWS OF THE DRAWING(S)

FIG. 1 is a side elevational view of a plug connector according to the present invention.

FIG. 2 is a cross-sectional view of the plug connector of FIG. 1, showing the internal cable configuration and couplings within the plug connector.

FIG. 3 is an end view of the contact insert 5 of FIGS. 1 and 2.

### DETAILED DESCRIPTION OF THE INVENTION

The invention proposes that, in a plug connector of the kind specified, a second cable bushing is provided on a plug housing such that, even though the first cable bushing of the plug connector receives two different cables, the second cable bushing nevertheless receives only one of the two cables (or additional cables).

The second cable bushing is preferably provided on a different side of the plug connector than the plug contact, so that the plug contact can be a standard plug contact (contact pin or other standardized contacts), for example, and that another conductor, for example, can be fed through the second cable bushing to a desired position.

Plug connectors according to the invention can be used, in particular, wherever a current, e.g., a control current, is transferred by a copper cable, on the one hand, and where waveguides can be also be used to transfer data, on the other hand, for example for high-speed transfer of data signals for controlling and/or diagnosing a wind turbine.

In a wind turbine, in particular, plug connectors of the kind specified by the invention can be deployed advantageously in power control cabinets.

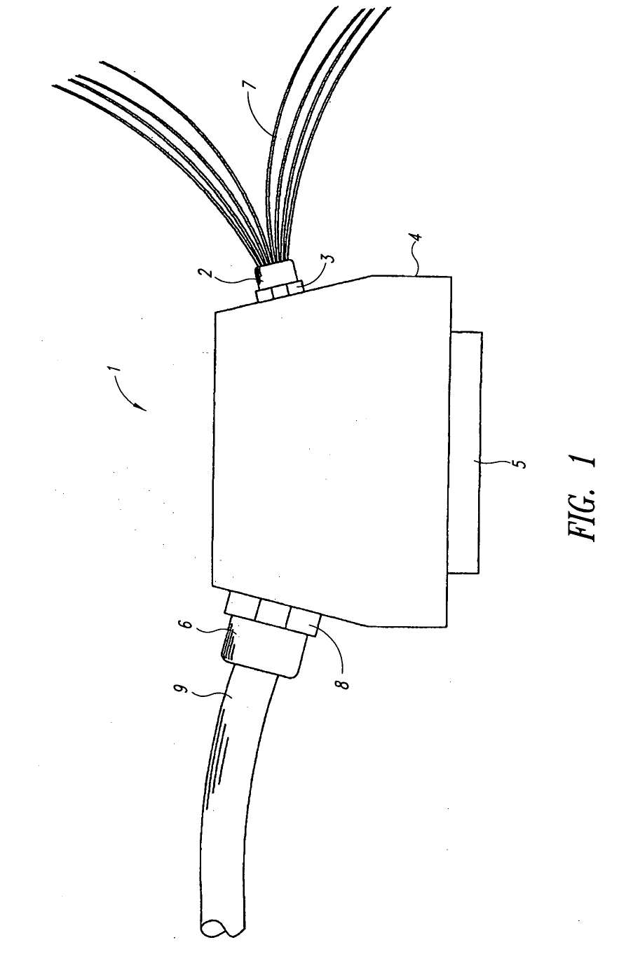

The invention shall now be described in greater detail with reference to an embodiment shown in FIG. 1. FIG. 1 shows a plug connector 1 with a first cable bushing 2 having a cable gland 3 mounted on the plug housing 4 for fixating cables 9, 7. The plug connector 1 according to the invention also has a plug contact insert 5 on one side of the plug housing, and a second second cable bushing 6 is provided on the opposite side of the plug housing from the first cable bushing 2.

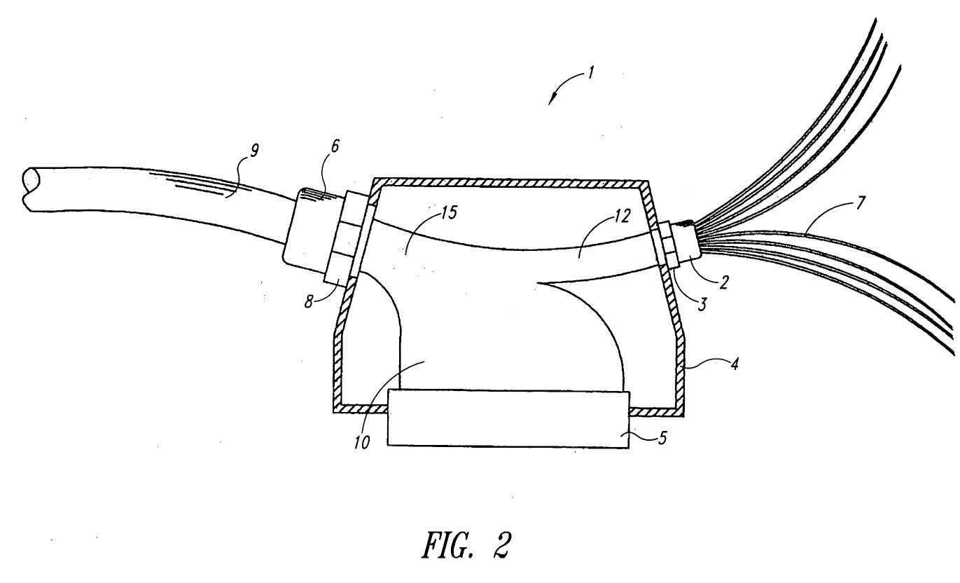

It can be seen from FIG. 2 that the joint cable 15 that goes through the second cable bushing 6 includes a plurality of different conductors of which some are connected to the plug contact insert 5 of the plug connector, whereas others are only fed through the plug housing 4 and exit through a first cable bushing 2 on the other side of the housing opposite the second cable bushing. The joint cable 15 that is fed through the second cable bushing is thus fixated to the plug housing, whereby another cable gland 8 can also be provided for the second cable bushing 6 in order to fixate the second set of conductors at the housing.

In the example shown, the separate leads of the first set of conductors (cable tree) 10 are copper leads with which a normal current or control data (control signals) can be transferred. The separate leads of the second set of conductors 7 are optical waveguides, i.e., leads using a different physical principle than the first set of conductors. Both are joined together to form the joint cable 15 inside the housing 4 that becomes cable 9 as it exits the housing.

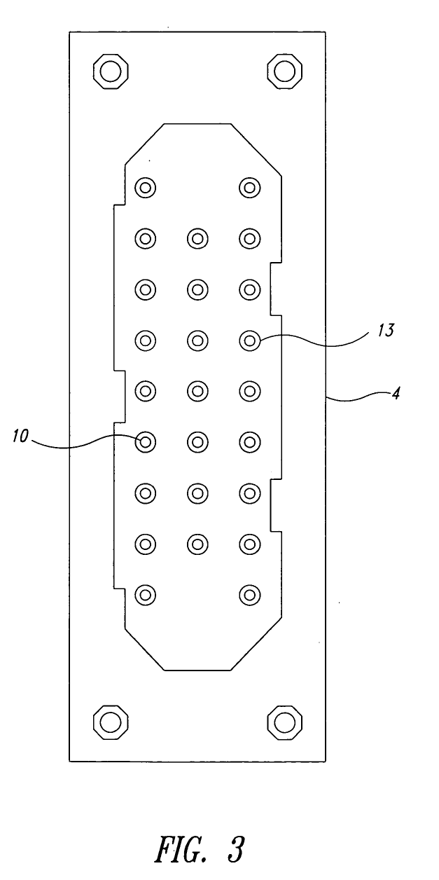

FIG. 3 shows a plan view of the contact insert 5, which may be a commonly known contact insert or and plug connected to the plug housing.

It houses female receptacles 13 coupled to the plug housing 4 that connect to the electrical conductors 10.

In contrast to the aforementioned citation DE 198 03 677, the invention discloses the technical principle that two types conductors are fed into the plug connector through a shared cable bushing 6 and that one of the two conductors is fed back out of the plug connector through a different cable bushing 2. However, this is an independent solution and not a loopthrough. One difference between the invention and the aforementioned citation is that, in prior art connectors, the second cable 12 is not fed back out of the plug without interruption. In the invention, in contrast, the cable 12 fed through the first bushing is fed back out again through the second bushing, without interruption, thus removing a potential source of faults.

The teaching of the invention has the advantage that cables containing conductors that operate according to different physical principles can be fed into the plug connector and that only galvanic conductors, for example, are connected to a suitably configured contact insert. Accordingly, said contact insert can be manufactured and provided simply and inexpensively, unlike contact inserts for connecting different physical systems. For example, it is possible in this way to connect galvanic conductors in the plug connection 5 and to simply feed the optical conductors 7 back out through a standard bushing 2, connect them in a separate plug connection designed for optical waveguides, and by this means connect them to a suitable mating piece.

The aforesaid variant of the plug connector thus functions to provide an excellent fixation means for the optical waveguide while combining the two different types of conductor leading to the plug connector, thus optimizing the stability of the conductor arrangement and feed paths and keeping them simple, particularly since both types of conductor leading to the plug are enclosed by the same jacket, as shown in FIGS. 1 and 2.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A plug connector comprising:
a plug housing;
a first bushing for a cable having at least a first electrical signal conductor and second conductor that is an optical waveguide within the cable;
a contact insert for the first conductor integrated in said housing;
a means for fixating the cable in the bushing area;
a second cable bushing for
the second conductor to pass through the housing through the second cable bushing.

2. The plug connector according to claim 1,
characterized in that the first conductor comprises a plurality of single conductors each connected to corresponding contacts of the contact insert.

3. The plug connector according to claim 1,
characterized in that the plug housing is made of plastic or metal.

4. The plug connector according to claim 1,
characterized in that the second cable bushing is provided on a different side of the plug housing than the contact insert.

5. The plug connector according to claim 1,
characterized in that the first conductor and the second conductor are joined into a common cable within the plug connector and pass through the second bushing within a single joint cable.

6. The plug connector according to claim 1,
characterized in that the second conductor is fed out of the housing without interruption.

7. A wind turbine with a power control cabinet inside which controllers are provided, wherein said power control cabinet has two different plug connectors of which one is connectable to the contact insert of the plug according to claim 1 and the other plug connector is connected to the optical waveguide.

8. A plug connector comprising:
a plug housing;
an electrical contact insert coupled to the housing, the electrical contact insert having a plurality of electrically conductive sockets for receiving a connector from outside the plug housing;
a first signal conductor within the housing, the first signal conductor being an electrical conductor connected to the contact insert; and
a first bushing coupled to the plug housing;
a second signal conductor which enters the plug housing via the first bushing, the second signal conductor being an optical waveguide for carrying data;
a joint cable within the plug housing which contains the first conductor and the second conductor to provide a single cable having both types of conductors therein; and
a second bushing coupled to the plug housing through which the joint cable passes.

9. The plug connector according to claim 8, wherein the contact insert has a plurality of electrically conductive female receptacles for receiving an electrically conductive male jack.
